(19) United States
(12) Patent Application Publication
(10) Pub. No.: US 2017/0006437 A1
(43) Pub. Date: Jan. 5, 2017

(54) GROUP COMMUNICATION APPARATUS AND METHOD

(71) Applicant: HUAWEI TECHNOLOGIES CO., LTD., Shenzhen (CN)

(72) Inventors: Fangfu GUO, Shanghai (CN); Xiaoxiao ZHENG, Shanghai (CN); Yi ZHANG, Shanghai (CN); LingIi PANG, Shanghai (CN)

(73) Assignee: HUAWEI TECHNOLOGIES CO., LTD., Shenzhen (CN)

(21) Appl. No.: 15/265,059

(22) Filed: Sep. 14, 2016

Related U.S. Application Data
(63) Continuation of application No. PCT/CN2014/073713, filed on Mar. 19, 2014.

(51) Int. Cl. H04W 4/06; H04L 1/18; H04W 36/00; H04W 72/04

(52) U.S. Cl. CPC H04W 4/06; H04W 72/0413; H04L 1/1861; H04W 36/0016

(57) ABSTRACT

According to a group communication apparatus and method provided by the present invention, uplink feedback information is configured for some or all UEs in a group of UEs that receive group communication service data packet, so that the group communication apparatus can control downlink data transmission according to uplink feedback information fed back by UE, for example, a suitable MCS is determined and HARQ retransmission is performed, thereby improving reliability and transmission efficiency of group communication service data packet transmission.

### CROSS-REFERENCE TO RELATED APPLICATIONS

This application is a continuation of International Application No. PCT/CN2014/073713, filed on Mar. 19, 2014, the disclosure of which is hereby incorporated by reference in its entirety.

### TECHNICAL FIELD

The present invention relates to communications technologies, and in particular, to a group communication apparatus and method.

### BACKGROUND

With development of an intelligent terminal, an increasing quantity of people are accustomed to watching, by using the intelligent terminal, a variety show live telecast, a sports live telecast, a national satellite television synchronous live telecast, and the like. All these live services have a common characteristic, that is, all these live services belong to a group communication service, where the group communication service refers to that different users receive same service data packet at the same time.

A Universal Mobile Telecommunications System (UMTS) is used as an example. In the prior art, a point-to-multipoint (PtM) manner is used to transfer group communication service data packet to different user equipments (UE) that are interested in the foregoing group communication service data packet. Specifically, after UE that supports a multimedia broadcast multicast service (MBMS) mode enables the MBMS mode, and a radio network controller (RNC) receives the group communication service data packet from a core network, a forward access channel (FACH) is used to carry an MBMS point-to-multipoint control channel (MCCH)/MBMS point-to-multipoint traffic channel (MTCH)/MBMS point-to-multipoint scheduling channel (MSCH) of an MBMS, and after the group communication service data packet is transferred to a base station, the base station uses a secondary common control physical channel (S-CCPCH) to carry the FACH, and the different UEs that are interested in the group communication service data packet acquire the group communication service data packet from the S-CCPCH.

However, because the base station in the prior art uses the S-CCPCH to carry the FACH, and the existing S-CCPCH has no feedback mechanism, communication quality of a group communication service cannot be ensured.

### SUMMARY

Embodiments of the present invention provide a group communication apparatus and method, so as to improve reliability of a group communication service.

A first aspect of the embodiments of the present invention provides a group communication apparatus, where the apparatus includes: a determining module, configured to determine whether a received downlink data packet is a group communication service data packet, where the group communication service data packet is corresponding to a group of user equipments (UEs), the group of UEs include N UEs, and N is an integer that is greater than or equal to 1; and a processing module, configure to: if the received downlink data packet is the group communication service data packet, determine to transmit the group communication service data packet on a physical downlink shared channel or a physical multicast channel, and control transmission of the group communication service data packet according to uplink feedback information fed back by M UEs in the N UEs, where M is an integer that is greater than or equal to 1, and 1≦M≦N.

With reference to the first aspect, in a first possible implementation manner, the processing module includes: a first processing unit, configured to determine, according to the uplink feedback information fed back by the M UEs in the N UEs, a modulation and coding scheme (MCS) used to transmit the group communication service data packet; and/or a second processing unit, configured to: perform a hybrid automatic repeat request (HARQ) retransmission decision according to the uplink feedback information fed back by the M UEs in the N UEs, and if a result of the decision is retransmission, perform HARQ retransmission on the group communication service data packet.

With reference to the first possible implementation manner, in a second possible implementation manner, the uplink feedback information includes: a channel quality indicator (CQI); and the first processing unit is specifically configured to: rank received current CQI values fed back by the M UEs, and determine, according to a current CQI value that is ranked in the Lth place, the MCS used to transmit the group communication service data packet, where L is an integer that is greater than or equal to 1, and 1≦L≦M; or determine, according to a current CQI value of UE whose average CQI value is the smallest in the M UEs, the MCS used to transmit the group communication service data packet; or rank received current CQI values fed back by the M UEs, and determine, according to an average value of current CQI values that are ranked from the Rth place to the Qth place, the MCS used to transmit the group communication service data packet, where R is an integer that is greater than or equal to 1, Q is an integer that is greater than or equal to 2, and 1≦R≦Q≦M.

With reference to the first or the second possible implementation manner, in a third possible implementation manner, the uplink feedback information further includes: an acknowledgment (ACK) or a negative acknowledgment (NACK); and the second processing unit is specifically configured to: if an NACK fed back by at least one UE in the M UEs is received, perform, on the physical downlink shared channel, HARQ retransmission on a group communication service data packet corresponding to the NACK; or collect statistics about received ACK and NACK information that is fed back by the M UEs by using an uplink feedback channel and that is for a same group communication service data packet, calculate a total block error rate, and if the total block error rate is greater than or equal to a preset total block error rate threshold, perform HARQ retransmission on the group communication service data packet on the physical downlink shared channel; or separately collect statistics about a data transmission block error rate (BLER) of each UE in the M UEs, and when the M UEs receive a group communication data packet, and a BLER of at least one UE in the M UEs is greater than or equal to a preset BLER threshold, perform HARQ retransmission on the group communication data packet on the physical downlink shared channel.

With reference to the first possible implementation manner, in a fourth possible implementation manner, if the N UEs have a capability of supporting multiple carriers, the processing module further includes a third processing unit and a fourth processing unit, where the third processing unit is configured to determine to map, at a first frequency channel number, the corresponding group communication service data packet to the physical downlink shared channel for transmission; and the fourth processing unit is configured to map, at a second frequency channel number, the corresponding group communication service data packet to the physical downlink shared channel for performing HARQ retransmission.

With reference to the first possible implementation manner, in a fifth possible implementation manner, the processing module further includes: a third processing unit and a fourth processing unit, where

the third processing unit is configured to determine to map the group communication service data packet to the physical multicast channel for transmission; and

the fourth processing unit is configured to map the group communication service data packet to the physical downlink shared channel for performing HARQ retransmission.

With reference to the first aspect, in a sixth possible implementation manner, when the group communication apparatus is an evolved NodeB, the apparatus further includes: a configuration module, configured to configure the uplink feedback information of the M UEs in the N UEs, where 1≦M≦N, and the M UEs are UEs, in the N UEs, that are determined by the group communication apparatus and that satisfy a preset condition; where the preset condition is at least one of the following conditions: all UEs in the N UEs; UE, in the N UEs, whose reference signal received power (RSRP) is less than a preset RSRP threshold or reference signal received quality (RSRQ) is less than a preset RSRQ threshold; UE, in the N UEs, whose CQI is less than a preset CQI threshold; UE, in the N UEs, whose data transmission BLER on the physical downlink shared channel or the physical multicast channel is greater than a preset BLER threshold; and UE, in the N UEs, that is in a handover area.

With reference to the first aspect, in a seventh possible implementation manner, when the group communication apparatus is a base station, the processing module is specifically configured to control the transmission of the group communication service data packet according to the uplink feedback information fed back by the M UEs, in the N UEs, that are configured by a radio network controller (RNC) corresponding to the group communication apparatus, where the M UEs, in the N UEs, configured by the RNC are UEs that satisfy a preset condition; where the preset condition is at least one of the following conditions: all UEs in the N UEs; UE, in the N UEs, whose received signal code power RSCP is less than a preset RSCP threshold or

$$\frac{{E}_{c}}{{I}_{o}}$$

is less than a preset

$$\frac{{E}_{c}}{{I}_{o}}$$

threshold; UE, in the N UEs, whose CQI is less than a preset CQI threshold; UE, in the N UEs, whose data transmission BLER on the physical downlink shared channel or the physical multicast channel is greater than a preset BLER threshold; and UE, in the N UEs, that is in a handover area or a softer handover area.

With reference to the first aspect or any possible implementation manner of the first to the fifth possible implementation manners of the first aspect, in an eighth possible implementation manner, the apparatus further includes: a configuration module, configured to send a reported threshold to the N UEs by using a radio resource control (RRC) message, where the reported threshold is a CQI threshold and/or a BLER threshold, so that each UE in the N UEs determines, according to the reported threshold, whether to perform uplink information feedback.

With reference to the first aspect, in a ninth possible implementation manner, the apparatus further includes:

a receiving module, configured to receive a resource allocation request sent by the M UEs in the N UEs; and

a sending module, configured to send a resource allocation response to the M UEs, where the resource allocation response includes an indication of a resource allocated for the M UEs, so that the M UEs feed back the uplink feedback information on a resource corresponding to the indication of the allocated resource.

A second aspect of the embodiments of the present invention provides a group communication apparatus, where the apparatus includes:

a receiving module, configured to receive group communication data by using a physical downlink shared channel or a physical multicast channel; and

a processing module, configured to determine, according to a reported threshold carried in a received radio resource control message, whether uplink information feedback needs to be performed, where the reported threshold is a channel quality indicator (CQI) threshold and/or a block error rate (BLER) threshold.

With reference to the second aspect, in a first possible implementation manner, the processing module is specifically configured to: when a BLER of the received group communication data is greater than the BLER threshold, determine to perform the uplink information feedback; or when a measured CQI is less than the CQI threshold, determine to perform the uplink information feedback.

With reference to the first possible implementation manner, in a second possible implementation manner, the apparatus further includes: a sending module, configured to send a resource allocation request to the group communication apparatus; where

the receiving module is further configured to receive a resource allocation response sent by the group communication apparatus, where the resource allocation response includes an indication of a resource allocated for M UEs by the group communication apparatus; and

the processing module is further configured to feed back uplink feedback information on a resource corresponding to the indication of the allocated resource.

A third aspect of the embodiments of the present invention provides a group communication method, where the method includes: determining, by a group communication apparatus, whether a received downlink data packet is a group communication service data packet, where the group communication service data packet is corresponding to a group of user equipments (UEs), the group of UEs include N UEs, and N is an integer that is greater than or equal to 1; and if the downlink data packet received by the group communication apparatus is the group communication service data packet, determining, by the group communication apparatus, to transmit the group communication service data packet on a physical downlink shared channel or a physical multicast channel, and controlling transmission of the group communication service data packet according to uplink feedback information fed back by M UEs in the N UEs, where M is an integer that is greater than or equal to 1, and 1≦M≦N.

With reference to the third aspect, in a first possible implementation manner, the controlling transmission of the group communication service data packet according to uplink feedback information fed back by M UEs in the N UEs includes: determining, by the group communication apparatus according to the uplink feedback information fed back by the M UEs in the N UEs, a modulation and coding scheme (MCS) used to transmit the group communication service data packet; and/or performing, by the group communication apparatus, a hybrid automatic repeat request (HARQ) retransmission decision according to the uplink feedback information fed back by the M UEs in the N UEs, and if a result of the decision is retransmission, performing, by the group communication apparatus, HARQ retransmission on the group communication service data packet.

With reference to the first possible implementation manner, in a second possible implementation manner, the uplink feedback information includes: a channel quality indicator (CQI); and the determining, by the group communication apparatus according to the uplink feedback information fed back by the M UEs in the N UEs, an MCS used to transmit the group communication service data packet includes: ranking, by the group communication apparatus, received current CQI values fed back by the M UEs, and determining, according to a current CQI value that is ranked in the Lth place, the MCS used to transmit the group communication service data packet, where L is an integer that is greater than or equal to 1, and 1≦L≦M; or determining, by the group communication apparatus according to a current CQI value of UE whose average CQI value is the smallest in the M UEs, the MCS used to transmit the group communication service data packet; or ranking, by the group communication apparatus, received current CQI values fed back by the M UEs, and determining, according to an average value of current CQI values that are ranked from the Rth place to the Qth place, the MCS used to transmit the group communication service data packet, where R is an integer that is greater than or equal to 1, Q is an integer that is greater than or equal to 2, and 1≦R≦Q≦M.

With reference to the first or the second possible implementation manner, in a third possible implementation manner, the uplink feedback information further includes: an acknowledgment (ACK) or a negative acknowledgment (NACK); and the performing, by the group communication apparatus, an HARQ retransmission decision according to the uplink feedback information fed back by the M UEs in the N UEs includes: if an NACK fed back by at least one UE in the M UEs is received, performing, by the group communication apparatus on the physical downlink shared channel, HARQ retransmission on a group communication service data packet corresponding to the NACK; or collecting, by the group communication apparatus, statistics about received ACK and NACK information that is fed back by the M UEs by using an uplink feedback channel and that is for a same group communication service data packet, calculating a total block error rate, and if the total block error rate is greater than or equal to a preset total block error rate threshold, performing HARQ retransmission on the group communication service data packet on the physical downlink shared channel; or separately collecting, by the group communication apparatus, statistics about a data transmission block error rate (BLER) of each UE in the M UEs, and when the M UEs receive a group communication data packet, and a BLER of at least one UE in the M UEs is greater than or equal to a preset BLER threshold, performing HARQ retransmission on the group communication data packet on the physical downlink shared channel.

With reference to the first possible implementation manner, in a fourth possible implementation manner, if the N UEs have a capability of supporting multiple carriers, the determining, by the group communication apparatus, to transmit the group communication service data packet on a physical downlink shared channel or a physical multicast channel includes: determining, by the group communication apparatus, to map, at a first frequency channel number, the group communication service data packet to the physical downlink shared channel for transmission; and the performing, by the group communication apparatus, HARQ retransmission on the group communication service data packet includes: mapping, by the group communication apparatus at a second frequency channel number, the group communication service data packet to the physical downlink shared channel for performing HARQ retransmission.

With reference to the first possible implementation manner, in a fifth possible implementation manner,

the group communication apparatus determines to map the group communication service data packet to the physical multicast channel for transmission; and

the performing, by the group communication apparatus, HARQ retransmission on the group communication service data packet includes:

mapping, by the group communication apparatus, the group communication service data packet to the physical downlink shared channel for performing HARQ retransmission.

With reference to the third aspect, in a sixth possible implementation manner, when the group communication apparatus is an evolved NodeB, the method further includes: configuring, by the group communication apparatus, the uplink feedback information of the M UEs in the N UEs, where 1≦M≦N, and the M UEs are UEs, in the N UEs, that are determined by the group communication apparatus and that satisfy a preset condition; where the preset condition is at least one of the following conditions: all UEs in the N UEs; UE, in the N UEs, whose reference signal received power (RSRP) is less than a preset RSRP threshold or reference signal received quality (RSRQ) is less than a preset RSRQ threshold; UE, in the N UEs, whose CQI is less than a preset CQI threshold; UE, in the N UEs, whose data transmission BLER on the physical downlink shared channel or the physical multicast channel is greater than a preset BLER threshold; and UE, in the N UEs, that is in a handover area.

With reference to the third aspect, in a seventh possible implementation manner, when the group communication apparatus is a base station, the controlling transmission of the group communication service data packet according to uplink feedback information fed back by M UEs in the N UEs includes: controlling, by the group communication apparatus, the transmission of the group communication service data packet according to the uplink feedback information fed back by the M UEs, in the N UEs, that are configured by a radio network controller (RNC) corresponding to the group communication apparatus, where the M UEs, in the N UEs, configured by the RNC are UEs that satisfy a preset condition; where the preset condition is at least one of the following conditions: all UEs in the N UEs; UE, in the N UEs, whose received signal code power RSCP is less than a preset RSCP threshold or

$$\frac{{E}_{c}}{{I}_{o}}$$

is less than a preset

$$\frac{{E}_{c}}{{I}_{o}}$$

threshold; UE, in the N UEs, whose CQI is less than a preset CQI threshold; UE, in the N UEs, whose data transmission BLER on the physical downlink shared channel or the physical multicast channel is greater than a preset BLER threshold; and UE, in the N UEs, that is in a handover area or a softer handover area.

With reference to the third aspect or any possible implementation manner of the first to the fifth possible implementation manners of the third aspect, in an eighth possible implementation manner, the method further includes: sending, by the group communication apparatus, a reported threshold to the N UEs by using a radio resource control message, where the reported threshold is a CQI threshold and/or a BLER threshold, so that each UE in the N UEs determines, according to the reported threshold, whether to perform uplink information feedback.

With reference to the third aspect, in a ninthpossible implementation manner, before the controlling transmission of the group communication service data packet according to uplink feedback information fed back by M UEs in the N UEs, the method further includes:

receiving, by the group communication apparatus, a resource allocation request sent by the M UEs in the N UEs; and

sending, by the group communication apparatus, a resource allocation response to the M UEs, where the resource allocation response includes an indication of a resource allocated for the M UEs by the group communication apparatus, so that the M UEs feed back the uplink feedback information on a resource corresponding to the indication of the allocated resource.

A fourth aspect of the embodiments of the present invention provides a group communication method, where the method includes:

receiving, by user equipment UE, group communication data by using a physical downlink shared channel or a physical multicast channel; and

determining, by the UE according to a reported threshold carried in a received radio resource control message, whether uplink information feedback needs to be performed, where the reported threshold is a channel quality indicator (CQI) threshold and/or a block error rate (BLER) threshold.

With reference to the fourth aspect, in a first possible implementation manner, the determining, by the UE according to a reported threshold carried in a received radio resource control message, whether uplink information feedback needs to be performed includes:

when a BLER of the group communication data received by UE is greater than the BLER threshold, determining to perform the uplink information feedback; or

when a CQI measured by the UE is less than the CQI threshold, determining to perform the uplink information feedback.

With reference to the first possible implementation manner, in a second possible implementation manner, after the determining to perform the uplink information feedback, the method further includes:

sending, by the UE, a resource allocation request to a group communication apparatus;

receiving, by the UE, a resource allocation response sent by the group communication apparatus, where the resource allocation response includes an indication of a resource allocated for M UEs by the group communication apparatus; and

feeding back, by the UE, uplink feedback information on a resource corresponding to the indication of the allocated resource.

A fifth aspect of the embodiments of the present invention provides a group communication apparatus, where the apparatus includes: a receiver, configured to receive a downlink data packet; and a processor, configured to: determine whether the received downlink data packet is a group communication service data packet, where the group communication service data packet is corresponding to a group of user equipments (UEs), the group of UEs include N UEs, and N is an integer that is greater than or equal to 1; and if the received downlink data packet is the group communication service data packet, determine to transmit the group communication service data packet on a physical downlink shared channel or a physical multicast channel, and control transmission of the group communication service data packet according to uplink feedback information fed back by M UEs in the N UEs, where M is an integer that is greater than or equal to 1, and 1≦M≦N.

With reference to the fifth aspect, in a first possible implementation manner, the processor is specifically configured to: determine, according to the uplink feedback information fed back by the M UEs in the N UEs, a modulation and coding scheme (MCS) used to transmit the group communication service data packet; and/or perform a hybrid automatic repeat request (HARQ) retransmission decision according to the uplink feedback information fed back by the M UEs in the N UEs, and if a result of the decision is retransmission, perform HARQ retransmission on the group communication service data packet.

With reference to the first possible implementation manner, in a second possible implementation manner, the uplink feedback information includes: a channel quality indicator (CQI); and the processor is specifically configured to: rank received current CQI values fed back by the M UEs, and determine, according to a current CQI value that is ranked in the Lth place, the MCS used to transmit the group communication service data packet, where L is an integer that is greater than or equal to 1, and 1≦L≦M; or determine, according to a current CQI value of UE whose average CQI value is the smallest in the M UEs, the MCS used to transmit the group communication service data packet; or rank received current CQI values fed back by the M UEs, and determine, according to an average value of current CQI values that are ranked from the Rth place to the Qth place, the MCS used to transmit the group communication service data packet, where R is an integer that is greater than or equal to 1, Q is an integer that is greater than or equal to 2, and 1≦R≦Q≦M.

With reference to the first or the second possible implementation manner, in a third possible implementation manner, the uplink feedback information further includes: an acknowledgment (ACK) or a negative acknowledgment (NACK); and the processor is specifically configured to: if an NACK fed back by at least one UE in the M UEs is received, perform, on the physical downlink shared channel, HARQ retransmission on a group communication service data packet corresponding to the NACK; or collect statistics about received ACK and NACK information that is fed back by the M UEs by using an uplink feedback channel and that is for a same group communication service data packet, calculate a total block error rate, and if the total block error rate is greater than or equal to a preset total block error rate threshold, perform HARQ retransmission on the group communication service data packet on the physical downlink shared channel; or separately collect statistics about a data transmission block error rate (BLER) of each UE in the M UEs, and when the M UEs receive a group communication data packet, and a BLER of at least one UE in the M UEs is greater than or equal to a preset BLER threshold, perform HARQ retransmission on the group communication data packet on the physical downlink shared channel.

With reference to the first possible implementation manner, in a fourth possible implementation manner, if the N UEs have a capability of supporting multiple carriers, the processor is specifically configured to: determine to map, at a first frequency channel number, the corresponding group communication service data packet to the physical downlink shared channel for transmission; and map, at a second frequency channel number, the corresponding group communication service data packet to the physical downlink shared channel for performing HARQ retransmission.

With reference to the first possible implementation manner, in a fifth possible implementation manner, the processor is specifically configured to: determine to map the group communication service data packet to the physical multicast channel for transmission; and map the group communication service data packet to the physical downlink shared channel for performing HARQ retransmission.

With reference to the fifth aspect, in a sixth possible implementation manner, when the group communication apparatus is an evolved NodeB, the processor is further configured to configure the uplink feedback information of the M UEs in the N UEs, where 1≦M≦N, and the M UEs are UEs, in the N UEs, that are determined by the group communication apparatus and that satisfy a preset condition; where the preset condition is at least one of the following conditions: all UEs in the N UEs; UE, in the N UEs, whose reference signal received power (RSRP) is less than a preset RSRP threshold or reference signal received quality (RSRQ) is less than a preset RSRQ threshold; UE, in the N UEs, whose CQI is less than a preset CQI threshold; UE, in the N UEs, whose data transmission BLER on the physical downlink shared channel or the physical multicast channel is greater than a preset BLER threshold; and UE, in the N UEs, that is in a handover area.

With reference to the fifth aspect, in a seventh possible implementation manner, when the group communication apparatus is a base station, the processor is specifically configured to control the transmission of the group communication service data packet according to the uplink feedback information fed back by the M UEs, in the N UEs, that are configured by a radio network controller (RNC) corresponding to the group communication apparatus, where the M UEs, in the N UEs, configured by the RNC are UEs that satisfy a preset condition; where the preset condition is at least one of the following conditions: all UEs in the N UEs; UE, in the N UEs, whose received signal code power RSCP is less than a preset RSCP threshold or

$$\frac{{E}_{c}}{{I}_{o}}$$

is less than a preset

$$\frac{{E}_{c}}{{I}_{o}}$$

threshold; UE, in the N UEs, whose CQI is less than a preset CQI threshold; UE, in the N UEs, whose data transmission BLER on the physical downlink shared channel or the physical multicast channel is greater than a preset BLER threshold; and UE, in the N UEs, that is in a handover area or a softer handover area.

With reference to the fifth aspect or any possible implementation manner of the first to the fifth possible implementation manners of the fifth aspect, in an eighth possible implementation manner, the processor is further configured to send a reported threshold to the N UEs by using a radio resource control message, where the reported threshold is a CQI threshold and/or a BLER threshold, so that each UE in the N UEs determines, according to the reported threshold, whether to perform uplink information feedback.

With reference to the fifth aspect, in a ninth possible implementation manner,

the receiver is further configured to receive a resource allocation request sent by the M UEs in the N UEs; and

the apparatus further includes a transmitter, configured to send a resource allocation response to the M UEs, where the resource allocation response includes an indication of a resource allocated for the M UEs, so that the M UEs feed back the uplink feedback information on a resource corresponding to the indication of the allocated resource.

A sixth aspect of the embodiments of the present invention provides a group communication apparatus, where the apparatus includes:

a receiver, configured to receive group communication data by using a physical downlink shared channel or a physical multicast channel; and

a processor, configured to determine, according to a reported threshold carried in a received radio resource control message, whether uplink information feedback needs to be performed, where the reported threshold is a channel quality indicator (CQI) threshold and/or a block error rate (BLER) threshold.

With reference to the sixth aspect, in a first possible implementation manner, the processor is specifically configured to:

when a BLER of the group communication data received by UE is greater than the BLER threshold, determine to perform the uplink information feedback; or when a CQI measured by the UE is less than the CQI threshold, determine to perform the uplink information feedback.

With reference to the first possible implementation manner, in a second possible implementation manner, the apparatus further includes:

a transmitter, configured to send a resource allocation request to the group communication apparatus; where

the receiver is further configured to receive a resource allocation response sent by the group communication apparatus, where the resource allocation response includes an indication of a resource allocated for M UEs by the group communication apparatus; and

the processor is further configured to feed back uplink feedback information on a resource corresponding to the indication of the allocated resource.

According to the group communication apparatus and method provided by the present invention, a group communication service data packet is transmitted on a physical downlink shared channel or a physical multicast channel, and transmission of the group communication service data packet is controlled according to uplink feedback information fed back by M UEs in N UEs, for example, a suitable MCS is determined and/or an HARQ retransmission decision is performed, so that reliability of a group communication service is improved, thereby improving air interface transmission efficiency.

### BRIEF DESCRIPTION OF DRAWINGS

To describe the technical solutions in the embodiments of the present invention more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic structural diagram of Embodiment 1 of a group communication apparatus according to the present invention;

FIG. 2 is a schematic structural diagram of Embodiment 2 of a group communication apparatus according to the present invention;

FIG. 3 is a schematic structural diagram of Embodiment 3 of a group communication apparatus according to the present invention;

FIG. 4 is a schematic structural diagram of Embodiment 4 of a group communication apparatus according to the present invention;

FIG. 5 is a schematic flowchart of Embodiment 1 of a group communication method according to the present invention;

FIG. 6 is a first-type architecture diagram of UMTS group communication on a radio access network side;

FIG. 7 is a second-type architecture diagram of UMTS group communication on a radio access network side;

FIG. 8 is a third-type architecture diagram of UMTS group communication on a radio access network side;

FIG. 9 is a fourth-type architecture diagram of UMTS group communication on a radio access network side;

FIG. 10 is a schematic structural diagram of Embodiment 5 of a group communication apparatus according to the present invention;

FIG. 11 is a schematic structural diagram of Embodiment 6 of a group communication apparatus according to the present invention; and

FIG. 12 is a schematic flowchart of Embodiment 2 of a group communication method according to the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

A main idea of the present invention is that, a group communication service data packet is mapped to a physical downlink shared channel or a physical multicast channel (PMCH) for transmission, and the transmission of the group communication service data packet is controlled according to uplink feedback information, for example, a modulation and coding scheme (MCS) that is suitable for transmitting the foregoing group communication service data packet is determined according to channel quality fed back by UE corresponding to the group communication service data packet, and it is determined, according to an acknowledgment (ACK) or a negative acknowledgment (NACK) fed back by the UE corresponding to the group communication service data packet, whether to perform hybrid automatic repeat request (HARQ) retransmission. The transmission of the group communication service data packet can be controlled according to the uplink feedback information; therefore, communication quality of a group communication service is improved.

Specific embodiments are used below to describe in detail the technical solutions of the present invention. The following several specific embodiments may be combined with each other, and a same or similar concept or process may not be described repeatedly in some embodiments.

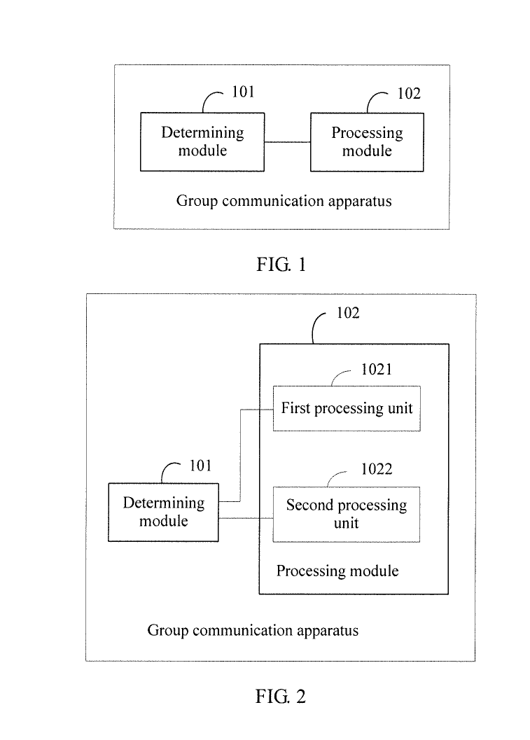

FIG. 1 is a schematic structural diagram of Embodiment 1 of a group communication apparatus according to the present invention. The group communication apparatus in this embodiment may be deployed inside a base station. In a UMTS system, the group communication apparatus is a NodeB (NodeB), and in a Long Term Evolution (LTE) system, the group communication apparatus is an evolved NodeB (eNodeB). The group communication apparatus in this embodiment includes a determining module 101 and a processing module 102, where the determining module 101 is configured to determine whether a received downlink data packet is a group communication service data packet, where the foregoing group communication service data packet is corresponding to a group of user equipments (UEs), the foregoing group of UEs include N UEs, and N is an integer that is greater than or equal to 1; the processing module 102 is configured to: if the foregoing received downlink data packet is the group communication service data packet, determine to transmit the foregoing group communication service data packet on a physical downlink shared channel or a physical multicast channel, and control transmission of the foregoing group communication service data packet according to uplink feedback information fed back by M UEs in the foregoing N UEs, where M is an integer that is greater than or equal to 1, and 1≦M≦N. If the foregoing received downlink data packet is a non-group communication service data packet, processing is performed according to another process.

In this embodiment, the group communication service data packet is transmitted on the physical downlink shared channel or the physical multicast channel by using the processing module, and the transmission of the group communication service data packet is controlled according to the uplink feedback information fed back by the M UEs in the N UEs, for example, a suitable MCS is determined and/or an HARQ retransmission decision is performed, so that reliability of a group communication service is improved, thereby improving air interface transmission efficiency.

In the foregoing embodiment, the foregoing apparatus further includes: a receiving module, configured to receive a resource allocation request sent by the M UEs in the N UEs; and a sending module, configured to send a resource allocation response to the foregoing M UEs, where the foregoing resource allocation response includes an indication of a resource allocated for the foregoing M UEs, so that the foregoing M UEs feed back the uplink feedback information on a resource corresponding to the indication of the foregoing allocated resource.

FIG. 2 is a schematic structural diagram of Embodiment 2 of a group communication apparatus according to the present invention. FIG. 2 is on the basis of the embodiment shown in FIG. 1. The processing module further includes a first processing unit 1021 and a second processing unit 1022, where the first processing unit 1021 is configured to determine, according to the uplink feedback information fed back by the M UEs in the foregoing N UEs, the modulation and coding scheme (MCS) used to transmit the foregoing group communication service data packet; and/or the second processing unit 1022 is configured to: perform a hybrid automatic repeat request (HARQ) retransmission decision according to the uplink feedback information fed back by the M UEs in the foregoing N UEs; and if a result of the decision is retransmission, perform HARQ retransmission on the foregoing group communication service data packet.

In the foregoing embodiment, the uplink feedback information includes: a channel quality indicator (CQI); and the foregoing first processing unit 1021 is specifically configured to: rank received current CQI values fed back by the M UEs, and determine, according to a current CQI value that is ranked in the Lth place, the MCS used to transmit the foregoing group communication service data packet, where L is an integer that is greater than or equal to 1, and 1≦L≦M; for example, it is assumed that M=10, and ranking is performed in a descending order, if L=10, that is, if MCS selection is performed according to a smallest CQI value, the MCS used to transmit the group communication service data packet is determined according to the smallest CQI value, which can ensure, to a largest extent, quality of receiving the group communication service data packet by the N UEs; if L=8, that is, if MCS selection is not performed according to the smallest CQI value, but according to a relatively smaller CQI value, quality of receiving the group communication service data packet by some UEs can be ensured, that is, quality of receiving the group communication service data packet by UEs separately corresponding to L=9 and L=10 cannot be ensured. Alternatively, the MCS used to transmit the foregoing group communication service data packet is determined according to a current CQI value of UE whose average CQI value is the smallest in the M UEs, where the UE whose average CQI value is the smallest refers to UE whose channel quality is the poorest, and the MCS used to transmit the foregoing group communication service data packet is determined according to the current CQI value of the UE, which can ensure, to a relatively large extent, quality of receiving the group communication service data packet by the N UEs. Alternatively, received current CQI values fed back by the M UEs are ranked, and the MCS used to transmit the foregoing group communication service data packet is determined according to an average value of current CQI values that are ranked from the Rth place to the Qth place, where R is an integer that is greater than or equal to 1, Q is an integer that is greater than or equal to 2, and 1≦R≦Q≦M; for example, ranking is performed in a descending order, and the MCS used to transmit the group communication service data packet is determined according to an average value of five CQI values that are ranked in the last, that is, the MCS may be determined according to average channel quality of the several UEs with poorer channel quality.

In the foregoing embodiment, the second processing unit 1022 is configured to: perform the HARQ retransmission decision according to the uplink feedback information fed back by the M UEs in the foregoing N UEs, and specifically, if an NACK fed back by at least one UE in the M UEs is received, perform, on the physical downlink shared channel, HARQ retransmission on a group communication service data packet corresponding to the foregoing NACK; or collect statistics about received ACK and NACK information that is fed back by the foregoing M UEs by using an uplink feedback channel and that is for a same group communication service data packet, calculate a total block error rate, where a formula for calculating the total block error rate is:

$$\frac{Quantity of NACKs}{Quantity of NACKs + Quantity of ACKs} ,$$

that is, a value obtained by dividing a quantity of received NACKs by a sum of a quantity of received ACKs and the quantity of received NACKs, and if the foregoing total block error rate is greater than or equal to a preset total block error rate threshold, perform HARQ retransmission on the foregoing group communication service data packet on the physical downlink shared channel; or separately collect statistics about a data transmission block error rate (BLER) of each UE in the foregoing M UEs, and when the foregoing M UEs receive a group communication data packet, and a BLER of at least one UE in the foregoing M UEs is greater than or equal to a preset BLER threshold, perform HARQ retransmission on the foregoing group communication data packet on the physical downlink shared channel.

In this embodiment, the first processing unit of the processing module is configured to determine, according to the uplink feedback information fed back by the M UEs in the foregoing N UEs, the MCS used to transmit the foregoing group communication service data packet; and the second processing unit is configured to perform the HARQ retransmission decision according to the uplink feedback information fed back by the M UEs in the foregoing N UEs, and if the result of the decision is retransmission, the foregoing group communication apparatus performs HARQ retransmission on the foregoing group communication service data packet, thereby improving reliability of a group communication service and air interface transmission efficiency.

In the foregoing embodiment, if the N UEs have a capability of supporting multiple carriers, the processing module further includes a third processing unit and a fourth processing unit, where the third processing unit is configured to determine to map, at a first frequency channel number, the foregoing corresponding group communication service data packet to the physical downlink shared channel for transmission; and the fourth processing unit is configured to map, at a second frequency channel number, the foregoing corresponding group communication service data packet to the physical downlink shared channel for performing HARQ retransmission.

In the foregoing embodiment, the processing module further includes: a third processing unit and a fourth processing unit, where the third processing unit is configured to determine to map the foregoing group communication service data packet to the physical multicast channel for transmission; and the foregoing fourth processing unit is configured to map the foregoing group communication service data packet to the physical downlink shared channel for performing HARQ retransmission.

In the foregoing embodiment, when the foregoing group communication apparatus is a base station, the foregoing processing module is specifically configured to control transmission of the foregoing group communication service data packet according to the uplink feedback information fed back by the M UEs, in the foregoing N UEs, that are configured by a radio network controller (RNC) corresponding to the foregoing group communication apparatus, where the M UEs, in the foregoing N UEs, configured by the foregoing RNC are UEs that satisfy a preset condition.

The foregoing preset condition is at least one of the following conditions: all UEs in the foregoing N UEs;

UE, in the foregoing N UEs, whose received signal code power (RSCP) is less than a preset RSCP threshold or

$$\frac{{E}_{c}}{{I}_{o}}$$

is less than a preset

$$\frac{{E}_{c}}{{I}_{o}}$$

threshold;

UE, in the foregoing N UEs, whose CQI is less than a preset CQI threshold;

UE, in the foregoing N UEs, whose data transmission BLER on the foregoing physical downlink shared channel or the physical multicast channel is greater than a preset BLER threshold; and

UE, in the foregoing N UEs, that is in a handover area or a softer handover area.

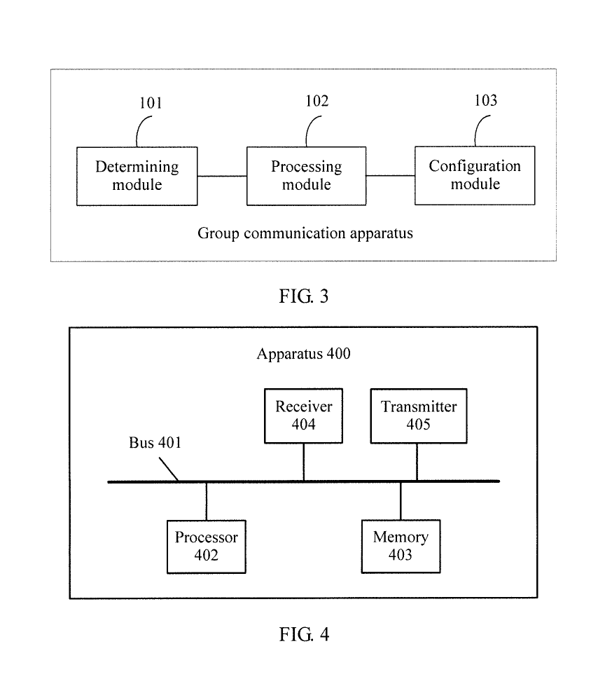

FIG. 3 is a schematic structural diagram of Embodiment 3 of a group communication apparatus according to the present invention. FIG. 3 is on the basis of the embodiment shown in FIG. 1. When the foregoing group communication apparatus is an evolved NodeB, the foregoing apparatus further includes: a configuration module 103, where the configuration module 103 is configured to configure the uplink feedback information of the M UEs in the foregoing N UEs, where 1≦M≦N, and the foregoing M UEs are UEs, in the foregoing N UEs, that are determined by the foregoing group communication apparatus and that satisfy a preset condition.

The foregoing preset condition is at least one of the following conditions:

all UEs in the foregoing N UEs;

UE, in the foregoing N UEs, whose reference signal received power (RSRP) is less than a preset RSRP threshold or reference signal received quality (RSRQ) is less than a preset RSRQ threshold;

UE, in the foregoing N UEs, whose CQI is less than a preset CQI threshold;

UE, in the foregoing N UEs, whose data transmission BLER on the physical downlink shared channel or the physical multicast channel is greater than a preset BLER threshold; and

UE, in the foregoing N UEs, that is in a handover area.

On the basis of the embodiment shown in FIG. 1, regardless of whether the group communication apparatus is the base station or the evolved NodeB, the foregoing group communication apparatus may further include a configuration module, configured to send a reported threshold to the N UEs by using a radio resource control message, where the foregoing reported threshold is a CQI threshold and/or a BLER threshold, so that each UE in the foregoing N UEs determines, according to the foregoing reported threshold, whether to perform uplink information feedback.

FIG. 10 is a schematic structural diagram of Embodiment 5 of a group communication apparatus according to the present invention. The group communication apparatus in this embodiment is integrated in UE, and the group communication apparatus in this embodiment includes: a receiving module 1001 and a processing module 1002, where the receiving module 1001 is configured to receive group communication data by using a physical downlink shared channel or a physical multicast channel; and the processing module 1002 is configured to determine, according to a reported threshold carried in a received radio resource control message, whether uplink information feedback needs to be performed, where the foregoing reported threshold is a CQI threshold and/or a BLER threshold.

In the foregoing embodiment, the foregoing processing module is specifically configured to: when a BLER of the foregoing received group communication data is greater than the BLER threshold, determine to perform the uplink information feedback; or when a measured CQI is less than the CQI threshold, determine to perform the uplink information feedback.

In the foregoing embodiment, the foregoing apparatus further includes a sending module, configured to send a resource allocation request to the group communication apparatus; the foregoing receiving module is further configured to receive a resource allocation response sent by the foregoing group communication apparatus, where the foregoing resource allocation response includes an indication of a resource allocated for M UEs by the foregoing group communication apparatus; and the foregoing processing module is further configured to feed back uplink feedback information on a resource corresponding to the indication of the foregoing allocated resource.

FIG. 4 is a schematic structural diagram of Embodiment 4 of a group communication apparatus according to the present invention. Referring to FIG. 4, this embodiment of the present invention provides a group communication apparatus 400, and the foregoing group communication apparatus 400 includes: a bus 401, and a processor 402, a memory 403, a receiver 404, and a transmitter 405 that are connected to the bus 401. The receiver is configured to receive a downlink data packet, and the memory 403 is configured to store an instruction. The processor 402 is configured to execute the foregoing instruction, and the foregoing instruction includes: determining whether the received downlink data packet is a group communication service data packet, where the foregoing group communication service data packet is corresponding to a group of user equipments (UEs), the foregoing group of UEs include N UEs, and N is an integer that is greater than or equal to 1; if the foregoing received downlink data packet is the group communication service data packet, determining to transmit the foregoing group communication service data packet on a physical downlink shared channel or a physical multicast channel, and controlling transmission of the foregoing group communication service data packet according to uplink feedback information fed back by M UEs in the foregoing N UEs, where M is an integer that is greater than or equal to 1, and 1≦M≦N.

In the foregoing embodiment, the receiver is further configured to receive a resource allocation request sent by the M UEs in the N UEs; and the transmitter is further configured to send a resource allocation response to the foregoing M UEs, where the foregoing resource allocation response includes an indication of a resource allocated for the foregoing M UEs, so that the foregoing M UEs feed back the uplink feedback information on a resource corresponding to the indication of the foregoing allocated resource.

In the foregoing embodiment, the foregoing processor 402 is specifically configured to determine, according to the uplink feedback information fed back by the M UEs in the foregoing N UEs, a modulation and coding scheme (MCS) used to transmit the foregoing group communication service data packet; and/or perform a hybrid automatic repeat request (HARQ) retransmission decision according to the uplink feedback information fed back by the M UEs in the foregoing N UEs, and if a result of the decision is retransmission, perform HARQ retransmission on the foregoing group communication service data packet.

In the foregoing embodiment, the foregoing uplink feedback information includes: a channel quality indicator (CQI); and the foregoing processor 402 is specifically configured to: rank received current CQI values fed back by the M UEs, and determine, according to a current CQI value that is ranked in the Lth place, the MCS used to transmit the foregoing group communication service data packet, where L is an integer that is greater than or equal to 1, and 1≦L≦M; or determine, according to a current CQI value of UE whose average CQI value is the smallest in the M UEs, the MCS used to transmit the foregoing group communication service data packet; or rank received current CQI values fed back by the M UEs, and determine, according to an average value of current CQI values that are ranked from the Rth place to the Qth place, the MCS used to transmit the foregoing group communication service data packet, where R is an integer that is greater than or equal to 1, Q is an integer that is greater than or equal to 2, and 1≦R≦Q≦M.

In the foregoing embodiment, the foregoing uplink feedback information further includes: an acknowledgment (ACK) or a negative acknowledgment (NACK); and the foregoing processor 402 is specifically configured to: if an NACK fed back by at least one UE in the M UEs is received, perform, on the physical downlink shared channel, HARQ retransmission on a group communication service data packet corresponding to the foregoing NACK; or collect statistics about received ACK and NACK information that is fed back by the foregoing M UEs by using an uplink feedback channel and that is for a same group communication service data packet, calculate a total block error rate, and if the foregoing total block error rate is greater than or equal to a preset total block error rate threshold, perform HARQ retransmission on the foregoing group communication service data packet on the physical downlink shared channel; or separately collect statistics about a data transmission block error rate (BLER) of each UE in the foregoing M UEs, and when the foregoing M UEs receive a group communication data packet, and a BLER of at least one UE in the foregoing M UEs is greater than or equal to a preset BLER threshold, perform HARQ retransmission on the foregoing group communication data packet on the physical downlink shared channel.

In the foregoing embodiment, if the foregoing N UEs have a capability of supporting multiple carriers, the foregoing processor 402 is specifically configured to: determine to map, at a first frequency channel number, the foregoing corresponding group communication service data packet to the physical downlink shared channel for transmission; and map, at a second frequency channel number, the foregoing corresponding group communication service data packet to the physical downlink shared channel for performing HARQ retransmission.

When the foregoing group communication service data packet is initially transmitted and mapped to the physical multicast channel for transmission, the foregoing processor 402 is specifically configured to: determine to map the foregoing group communication service data packet to the physical multicast channel for transmission; and map the foregoing group communication service data packet to the physical downlink shared channel for performing HARQ retransmission.

In the foregoing embodiment, when the foregoing group communication apparatus is an evolved NodeB, the foregoing processor 402 is further configured to configure the uplink feedback information of the M UEs in the foregoing N UEs, where 1≦M≦N, and the foregoing M UEs are UEs, in the foregoing N UEs, that are determined by the foregoing group communication apparatus and that satisfy a preset condition.

The foregoing preset condition is at least one of the following conditions:

all UEs in the foregoing N UEs;

UE, in the foregoing N UEs, whose reference signal received power (RSRP) is less than a preset RSRP threshold or reference signal received quality (RSRQ) is less than a preset RSRQ threshold;

UE, in the foregoing N UEs, whose CQI is less than a preset CQI threshold;

UE, in the foregoing N UEs, whose data transmission BLER on the physical downlink shared channel or the physical multicast channel is greater than a preset BLER threshold; and

UE, in the foregoing N UEs, that is in a handover area.

In the foregoing embodiment, when the foregoing group communication apparatus is a base station, the foregoing processor 402 is specifically configured to control transmission of the foregoing group communication service data packet according to the uplink feedback information fed back by the M UEs, in the foregoing N UEs, that are configured by a radio network controller (RNC) corresponding to the foregoing group communication apparatus, where the M UEs, in the foregoing N UEs, configured by the foregoing RNC are UEs that satisfy a preset condition.

The foregoing preset condition is at least one of the following conditions:

all UEs in the foregoing N UEs;

UE, in the foregoing N UEs, whose received signal code power RSCP is less than a preset RSCP threshold or

$$\frac{{E}_{c}}{{I}_{o}}$$

is less than a preset

$$\frac{{E}_{c}}{{I}_{o}}$$

threshold;

UE, in the foregoing N UEs, whose CQI is less than a preset CQI threshold;

UE, in the foregoing N UEs, whose data transmission BLER on the foregoing physical downlink shared channel or the physical multicast channel is greater than a preset BLER threshold; and

UE, in the foregoing N UEs, that is in a handover area or a softer handover area.

In the foregoing embodiment, the foregoing processor 402 is further configured to send a reported threshold to the N UEs by using a radio resource control message, where the foregoing reported threshold is a CQI threshold and/or a BLER threshold, so that each UE in the foregoing N UEs determines, according to the foregoing reported threshold, whether to perform uplink information feedback.

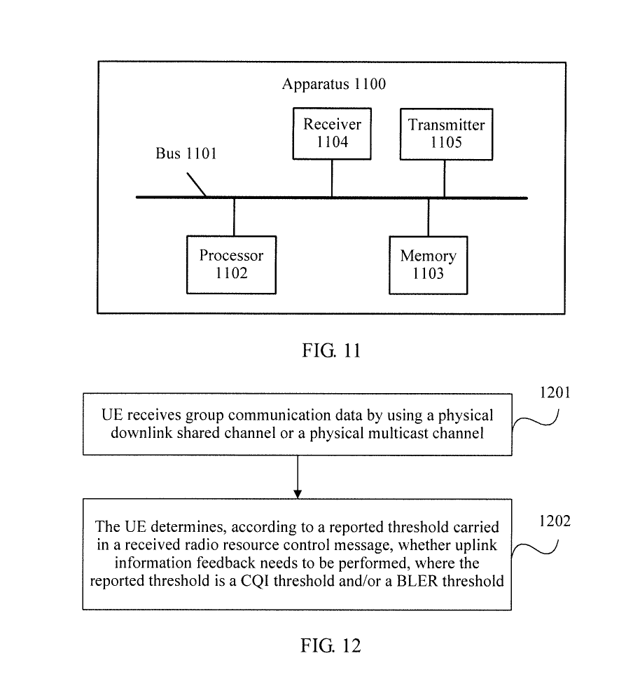

FIG. 11 is a schematic structural diagram of Embodiment 6 of a group communication apparatus according to the present invention. Referring to FIG. 11, this embodiment of the present invention provides a group communication apparatus 1100, where the group communication apparatus is integrated in UE, and the foregoing group communication apparatus 1100 includes: a bus 1101, and a processor 1102, a memory 1103, a receiver 1104, and a transmitter 1105 that are connected to the bus 1101. The receiver 1104 is configured to receive group communication data by using a physical downlink shared channel or a physical multicast channel, and the memory 1103 is configured to store an instruction. The processor 1102 is configured to execute the foregoing instruction, where the foregoing instruction includes: determining, according to a reported threshold carried in a received radio resource control message, whether uplink information feedback needs to be performed, where the foregoing reported threshold is a CQI threshold and/or a BLER threshold.

In the foregoing embodiment, the foregoing processor 1102 is specifically configured to: when a BLER of the foregoing group communication data received by the foregoing UE is greater than the BLER threshold, determine to perform the uplink information feedback; or when a CQI measured by the foregoing UE is less than the CQI threshold, determine to perform the uplink information feedback.

In the foregoing embodiment, the foregoing apparatus further includes the transmitter, configured to send a resource allocation request to the group communication apparatus; the foregoing receiver is further configured to receive a resource allocation response sent by the foregoing group communication apparatus, where the foregoing resource allocation response includes an indication of a resource allocated for M UEs by the foregoing group communication apparatus; and the foregoing processor is further configured to feed back uplink feedback information on a resource corresponding to the indication of the foregoing allocated resource.

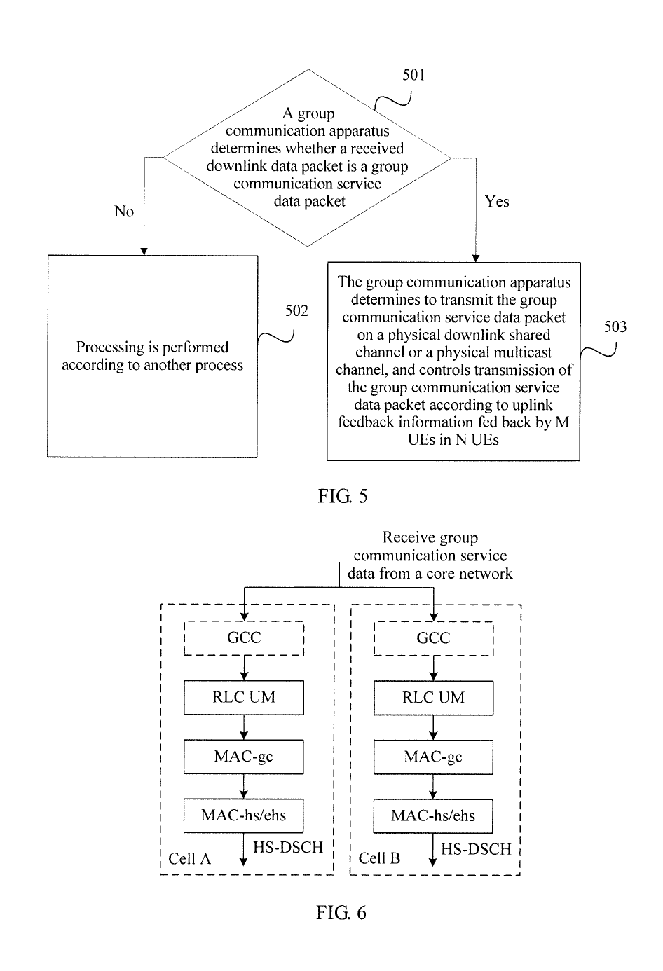

FIG. 5 is a schematic flowchart of Embodiment 1 of a group communication method according to the present invention. A group communication apparatus executes this embodiment, and the method is applicable to, but is not limited to, a UMTS system and an LTE system. In the UMTS system, the group communication apparatus is a NodeB (NodeB), and in the LTE system, the group communication apparatus is an eNodeB. As shown in FIG. 5, the method in this embodiment is as follows:

S501. The group communication apparatus determines whether a received downlink data packet is a group communication service data packet.

If the downlink data packet received by the group communication apparatus is a non-group communication service data packet, S502 is performed, and if the downlink data packet received by the group communication apparatus is the group communication service data packet, S503 is performed.

The group communication service data packet is corresponding to a group of user equipments (UEs), and the foregoing group of UEs include N UEs, where N is an integer that is greater than or equal to 1.

The determining whether a received downlink data packet is a group communication service data packet includes but is not limited to the following two manners.

First manner: It may be determined, by determining whether the downlink data packet carries a group identity, whether the downlink data packet is the group communication service data packet; if the downlink data packet carries a group identity, it is determined that the downlink data packet is the group communication service data packet, and a group of UEs corresponding to the group communication data packet are determined according to the group identity, and if the downlink data packet does not carry a group identity, it is determined that the downlink data packet is the non-group communication service data packet. Accordingly, the group of UEs corresponding to the group identity acquire the group communication service data packet from physical downlink shared channel or a physical multicast channel according to the foregoing group identity. Specifically, the group of UEs corresponding to the foregoing group identity may perform matching according to the foregoing group identity and a group identity of the group of UEs; if the foregoing group identity is the same as the group identity of the group of UEs, the foregoing group communication service data packet is acquired from the physical downlink shared channel or the physical multicast channel, and if the foregoing group identity is different from the group identity of the group of UEs, the foregoing group communication service data packet is not acquired.

Second manner: It is agreed that some specific virtual data channels are used to transmit the group communication service data packet, and each specific virtual data channel is corresponding to some group identities; if the downlink data packet is transmitted by using a virtual data channel used to transmit the group communication service data packet, it is determined that the downlink data packet is the group communication service data packet, and a group of UEs corresponding to the group communication service data packet are determined according to a correspondence between the virtual data channel and the group identities, or if the downlink data packet is not transmitted by using a virtual data channel used to transmit the group communication service data packet, it is determined that the downlink data packet is the non-group communication service data packet.

S502. Perform processing according to another process.

For example, the downlink data packet is mapped to a dedicated physical data channel (DPDCH) for transmission.

S503. The group communication apparatus determines to transmit the foregoing group communication service data packet on a physical downlink shared channel or a physical multicast channel, and controls transmission of the group communication service data packet according to uplink feedback information fed back by M UEs in N UEs.

M is an integer that is greater than or equal to 1, and 1≦M≦N. In the UMTS system, the group communication apparatus is a base station, and the M UEs in the N UEs are M UEs that are configured by an RNC corresponding to the base station and that satisfy a preset condition.

The foregoing preset condition is at least one of the following conditions:

all UEs in the foregoing N UEs;

UE, in the foregoing N UEs, whose RSCP is less than a preset RSCP threshold or

$$\frac{{E}_{c}}{{I}_{o}}$$

is less than a preset

$$\frac{{E}_{c}}{{I}_{o}}$$

threshold;

UE, in the foregoing N UEs, whose CQI is less than a preset CQI threshold;

UE, in the foregoing N UEs, whose data transmission BLER on the physical downlink shared channel or the physical multicast channel is greater than a preset BLER threshold; and

UE, in the foregoing N UEs, that is in a handover area or a softer handover area.

It can be seen that, the M UEs determined by the foregoing RNC according to a preset rule are UEs that are at a conditional cell edge, or whose channel quality is poor, or whose terminal performance is poor, because these UEs have a relatively high probability of failing to receive a data packet, or receiving an incomplete or a false data packet. The uplink feedback information is configured for these UEs, which is helpful in determining an MCS and performing an HARQ retransmission decision effectively on a network side.

The UEs that are at the cell edge or the UEs whose channel quality is poor may be determined in the following manners.

UE in a service connection establishment process may be determined by using a random access channel measurement result, that is, RSCP or Ec/Io, carried in a radio resource control connection request message; or a report of a CQI measurement value is added to a random access channel measurement result cell of the radio resource control connection request message, and the UE in the service connection establishment process may be determined by using a CQI measurement result.

For UE that has established a radio resource control (RRC) connection, it may be determined, by using CQI measurement according to a CQI measurement result that is of the UE and that is reported by the group communication apparatus, whether the UE is an edge user or a user whose channel quality is poor.

In the LTE system, the group communication apparatus is an evolved NodeB (eNodeB), and the M UEs in the N UEs are M UEs that are configured by the eNodeB and that satisfy a preset condition, where the foregoing preset condition is at least one of the following conditions:

all UEs in the foregoing N UEs;

UE, in the foregoing N UEs, whose RSRP is less than a preset RSRP threshold or RSRQ is less than a preset RSRQ threshold;

UE, in the foregoing N UEs, whose CQI is less than a preset CQI threshold;

UE, in the foregoing N UEs, whose data transmission BLER on the physical downlink shared channel or the physical multicast channel is greater than a preset BLER threshold; and

UE, in the foregoing N UEs, that is in a handover area.

After determining the M UEs, the RNC or the eNodeB configures the uplink feedback information for the foregoing determined M UEs. Specifically, the uplink feedback information includes: an ACK, a negative acknowledgment (NACK), and a CQI.

For example, in the UMTS system, specifically, a manner in which the RNC configures the uplink feedback information is described as follows:

Configuration of a feedback period of the CQI: The group communication apparatus may configure the feedback period of the CQI according to a value of M, that is, the feedback period of the CQI is dynamically configured according to a quantity of UEs, in a group of UEs in current multicast, that need to feed back HSDPA uplink feedback information, for example, when the quantity of UEs, in the group of UEs in the current multicast, that need to feed back the uplink feedback information is less than 10, the feedback period of the CQI is configured as 4 ms; when the quantity of UEs, in the group of UEs in the current multicast, that need to feed back the uplink feedback information ranges from 10 to 20, the feedback period of the CQI is configured as 8 ms; when the quantity of UEs, in the group of UEs in the current multicast, that need to feed back the uplink feedback information ranges from 20 to 40, the feedback period of the CQI is configured as 20 ms; when the quantity of UEs, in the group of UEs in the current multicast, that need to feed back the uplink feedback information is more than 40, the feedback period of the CQI is configured as 40 ms. The threshold configuration above is merely exemplary, and actual implementation is not limited to these thresholds.

Configuration of a power offset (PO) of the CQI: Reference may be made to parameter configuration of another common PtP service, that is, PO configuration of the CQI can ensure received quality of the group communication apparatus.

Configuration of a PO of the ACK: In one manner, reference may be made to parameter configuration of another common PtP service, that is, PO configuration of the ACK can ensure received quality of a first group communication apparatus; in another manner, for UE, in the M UEs that need to feed back the uplink feedback information, whose channel quality satisfies a preset value, the PO of the ACK is configured to be less than or equal to a first threshold, and generally, the first threshold is relatively small, that is, it cannot be ensured that the first group communication apparatus receives the ACK, that is, the first group communication apparatus may not consider ACK information fed back by UE whose channel quality is better; for UE, in the M UEs, whose channel quality does not satisfy the preset value, the PO of the ACK is configured to be greater than a second threshold, and generally, when the PO of the ACK is greater than or equal to the second threshold, it can be ensured that the first group communication apparatus receives ACK feedback, that is, it needs to be ensured that the first group communication apparatus can receive ACK information fed back by UE whose channel quality is poorer. The second threshold is greater than or equal to the first threshold. According to comparison between the foregoing two manners, in the latter manner, cell uplink load generated by feeding back an ACK is alleviated. A power offset PO of an ACK of each UE in the foregoing M UEs is a preset value, and the foregoing preset value may be a minimum value allowed by a protocol.

Configuration of a PO of the NACK: For the configuration of the PO of the NACK, reference may be made to parameter configuration of another common PtP service, that is, the configuration of the PO of the NACK can ensure that the group communication apparatus can receive an NACK fed back by UE.

In the foregoing several configuration solutions of the uplink feedback information, a preferred combination is that, the uplink feedback information is configured for all UEs in a same group (N=M), that is, all the UEs in the same group feed back, to the group communication apparatus, a status of receiving a group communication service data packet, where the feedback period of the CQI dynamically changes according to a quantity of UEs, in the group, that need to feed back the uplink feedback information, the PO of the CQI is configured with reference to a common PtP service, the PO of the ACK is configured as a minimum value, and the PO of the NACK is configured with reference to common PtP.

After receiving a data packet, UE configured with the uplink feedback information may feed back a parameter of the uplink feedback information to the base station, for example, the UE may feed back the CQI according to a CQI feedback mode configured by the RNC. After correctly receiving the data packet, the UE may feed back the ACK. When the UE does not correctly receive a data packet, the UE may feed back the NACK.

There is another manner for configuring the uplink feedback information, and this manner is applicable to, but is not limited to, the UMTS system and the LTE system. In the UMTS system, the RNC or the base station executes configuration, and in the LTE system, the eNodeB executes the configuration. In description of this manner, the RNC, or the base station, or the eNodeB is described as a network side, and the network side broadcasts a reported threshold to the foregoing N UEs, where the reported threshold is a CQI threshold and/or a BLER threshold, so that each UE in the foregoing N UEs determines, according to the foregoing reported threshold, whether to perform uplink information feedback. Specifically, the network side configures a CQI threshold or a BLER threshold for UE, and after receiving the threshold, the UE determines, according to a threshold decision, whether to perform the uplink information feedback (if a BLER is greater than the BLER threshold or a CQI is less than the CQI threshold, uplink information is fed back). There are two processes for feeding back the uplink information: One is that, after a condition of the foregoing threshold decision is satisfied, the uplink information feedback (including the ACK, the NACK, and the CQI) is immediately performed according to a related parameter configured by the network side; the other is that, after a condition of the foregoing threshold decision is satisfied, the UE first sends a resource allocation request to the network side, and then the network side returns a resource allocation response to the UE; after receiving the resource allocation response, the UE further performs the uplink information feedback on a resource indicated by the network side.

After the RNC or the base station or the eNodeB completes configuration of the uplink feedback information for the M UEs, the group communication apparatus (which is a base station in the UMTS, and is an eNodeB in the LTE) controls the transmission of the group communication service data packet according to the uplink feedback information fed back by the M UEs in the N UEs, which specifically includes:

determining, according to the uplink feedback information fed back by the M UEs in the N UEs, the modulation and coding scheme (MCS) used to transmit the foregoing group communication service data packet; and/or performing, by the foregoing group communication apparatus, a hybrid automatic repeat request (HARQ) retransmission decision according to the uplink feedback information fed back by the M UEs in the foregoing N UEs, and if a result of the decision is retransmission, performing, by the foregoing group communication apparatus, HARQ retransmission on the foregoing group communication service data packet.

Specifically, when the uplink feedback information includes a CQI, the determining, according to the uplink feedback information fed back by the M UEs in the N UEs, the modulation and coding scheme (MCS) used to transmit the group communication service data packet includes:

determining, by the group communication apparatus according to a smallest CQI value in received M CQIs, the MCS used to transmit the foregoing group communication service data packet; or determining, by the group communication apparatus according to a CQI value of UE whose average CQI value is the smallest in the M UEs, the MCS used to transmit the foregoing group communication service data packet; or determining, by the group communication apparatus with reference to CQIs of the foregoing M UEs, the MCS used to transmit the foregoing group communication service data packet.

When the uplink feedback information further includes an acknowledgment (ACK) or a negative acknowledgment (NACK), the performing, by the foregoing group communication apparatus, an HARQ retransmission decision according to the uplink feedback information fed back by the M UEs in the N UEs includes: if an NACK fed back by at least one UE in the M UEs is received, performing, by the foregoing group communication apparatus, HARQ retransmission on a group communication service data packet corresponding to the foregoing NACK; or collecting, by the foregoing group communication apparatus, statistics about received ACK and NACK information that is fed back by the foregoing M UEs by using an uplink feedback channel and that is for a same group communication service data packet, calculating a total block error rate, and if the foregoing total block error rate is greater than or equal to a preset total block error rate threshold, performing HARQ retransmission on the foregoing group communication service data packet; or separately collecting, by the foregoing group communication apparatus, statistics about a data transmission BLER of each UE in the foregoing M UEs, and when the foregoing M UEs receive a group communication data packet, and a BLER of at least one UE in the foregoing M UEs is greater than or equal to a preset BLER threshold, performing HARQ retransmission on the foregoing group communication data packet.

In this embodiment, the group communication service data packet is transmitted on the physical downlink shared channel or the physical multicast channel, and the transmission of the group communication service data packet is controlled according to the uplink feedback information fed back by the M UEs in the N UEs, for example, a suitable MCS is determined and/or an HARQ retransmission decision is performed, so that reliability of a group communication service is improved, thereby improving air interface transmission efficiency.

In the foregoing embodiment, if the N UEs have a capability of supporting multiple carriers, the group communication apparatus maps, at a first frequency channel number, the corresponding group communication service data packet to the physical downlink shared channel for transmission; and the group communication apparatus maps, at a second frequency channel number, the group communication service data packet to the physical downlink shared channel for performing HARQ retransmission. That is, initially transmitted data and retransmitted data are transmitted at different frequency channel numbers, and accordingly, UE receives, at different frequency channel numbers, the initially transmitted data and the retransmitted data.

In the foregoing embodiment, the group communication apparatus determines to map the foregoing group communication service data packet to the physical multicast channel for transmission; and the foregoing group communication apparatus maps the foregoing group communication service data packet to the physical downlink shared channel for performing HARQ retransmission. That is, if the initially transmitted data of the foregoing group communication data packet is carried on the physical multicast channel, the retransmitted data is transmitted on the physical downlink shared channel. That is, initial transmission and retransmission are performed on different physical channels.

In the foregoing embodiment, in the UMTS system, the RNC may notify in, but not limited to, the following manners, the base station whether the received downlink data packet is the group communication service data packet. In a first manner, group communication service data packet sent to the RNC by a core network carries a group identity, and after the RNC receives the group communication service data packet sent by the core network, the group communication service data packet is processed into a group communication service data packet that is suitable for downlink transmission, where the group communication service data packet includes the group identity carried in the group communication service data packet. In a second manner, a core network sends in advance a correspondence between a service type and a group identity to the RNC, and after the RNC receives group communication service data packet sent by the core network, a corresponding group identity may be determined according to a service type of the group communication service data packet. After the RNC determines that received core network data is group communication service data packet, and learns a group identity corresponding to the group communication service data packet, the RNC may include the group identity in a generated group communication service data packet, so that the foregoing base station determines whether the downlink data packet is the group communication service data packet, and determines a group corresponding to the group communication service data packet; or the RNC sends the group communication service data packet to the base station by using a virtual data channel corresponding to the group identity, so that the base station determines, according to the foregoing virtual data channel, whether the downlink data packet is the group communication service data packet.

Using the UMTS system as an example, the controlling, by the base station, the transmission of the foregoing group communication service data packet according to the uplink feedback information fed back by the M UEs in the foregoing N UEs includes the following several cases:

In a first case, the base station controls power of a physical downlink control channel according to the uplink feedback information fed back by the M UEs.

In a second case, the base station determines, according to the uplink feedback information fed back by the M UEs, an MCS used for the physical downlink shared channel during group communication.

In a third case, the base station performs an HARQ retransmission decision on the group communication service data packet according to the uplink feedback information fed back by the M UEs. That is, it is determined, according to ACK and NACK information fed back by the M UEs, whether to perform HARQ retransmission on the group communication data packet.

Control on downlink data transmission includes any one of the foregoing three types of control or a combination thereof.

Specifically, the foregoing first case may specifically include the following several implementation manners: The group communication apparatus controls the power of the physical downlink control channel according to the smallest CQI value in the received M COIs, that is, the power of the physical downlink control channel is controlled with reference to a CQI fed back by UE whose instantaneous channel quality is the poorest. Alternatively, the power of the physical downlink control channel is controlled according to an instantaneous CQI value of UE whose average CQI value is the smallest in the M UEs, that is, the power of the physical downlink control channel is controlled with reference to an instantaneous CQI of a user whose average channel quality is the poorest. Alternatively, the power of the physical downlink control channel is controlled according to a block error rate (BLER), obtained by means of measurement and statistics collection by the group communication apparatus, that is of the physical downlink control channel and that is received by each UE in the M UEs, for example, the BLER that is of the physical downlink control channel and that is received by each UE is controlled not to exceed a threshold (for example, 1%).

It should be noted that, by detecting discontinuous transmission (DTX), an ACK, and an NACK that are of an HS-DPCCH, the group communication apparatus measures and collects statistics about the BLER that is of the physical downlink control channel and that is received by each UE, and specifically, the BLER is obtained by calculation according to DTX/(ACK+NACK+DTX). If this solution for controlling the power of the physical downlink control channel is used, an ACK PO of an HS-DPCCH of UE whose channel quality is poor needs to be configured properly, and cannot be configured as a minimum value.

In the foregoing embodiment, for the UMTS system, the foregoing physical downlink shared channel may be a high speed physical downlink shared channel (HS-PDSCH), and the physical downlink control channel may be a high speed shared control channel (HS-SCCH). For the LTE system, the physical downlink shared channel is a physical downlink shared channel (PDSCH), and the physical downlink control channel is a physical downlink control channel (PDCCH).

The foregoing second case may specifically include the following several implementation manners: The group communication apparatus ranks received current CQI values fed back by the M UEs, and determines, according to a current CQI value that is ranked in the Lth place, the MCS used to transmit the foregoing group communication service data packet, where L is an integer that is greater than or equal to 1, and 1≦L≦M; for example, it is assumed that M=10, and ranking is performed in a descending order, if L=10, that is, if the MCS used to transmit the group communication service data packet is determined according to a smallest CQI value, the MCS used to transmit the group communication service data packet is determined according to the smallest CQI value, which can ensure, to a largest extent, quality of receiving the group communication service data packet by the N UEs; if L=8, that is, if MCS selection is not performed according to the smallest CQI value, but according to a relatively smaller CQI value, quality of receiving the group communication service data packet by some UEs can be ensured, that is, quality of receiving the group communication service data packet by UEs separately corresponding to L=9 and L=10 cannot be ensured. Alternatively, the MCS used to transmit the foregoing group communication service data packet is determined according to a current CQI value of UE whose average CQI value is the smallest in the M UEs, where the UE whose average CQI value is the smallest refers to UE whose channel quality is the poorest, and the MCS used to transmit the foregoing group communication service data packet is determined according to the current CQI value of the UE, which can ensure, to a relatively large extent, quality of receiving the group communication service data packet by the N UEs. Alternatively, received current CQI values fed back by the M UEs are ranked, and the MCS used to transmit the foregoing group communication service data packet is determined according to an average value of current CQI values that are ranked from the Rth place to the Qth place, where R is an integer that is greater than or equal to 1, Q is an integer that is greater than or equal to 2, and 1≦R≦Q≦M; for example, statistics about received M CQIs are collected, the CQIs are ranked in a descending order, and the MCS used to transmit the group communication service data packet is determined according to an average value of five CQI values that are ranked in the last, that is, the MCS may be determined according to an average channel quality level of the several UEs with poorer channel quality.

The foregoing third case may specifically include the following several implementation manners: If an NACK fed back by at least one UE in the M UEs is received, the group communication apparatus performs, on the physical downlink shared channel, HARQ retransmission on a group communication service data packet corresponding to the foregoing NACK, that is, as long as the group communication apparatus receives an NACK fed back by UE on an uplink feedback channel, the group communication apparatus performs HARQ retransmission on the corresponding group communication service data packet; or the group communication apparatus collects statistics about received ACK and NACK information that is fed back by the foregoing M UEs by using an uplink feedback channel and that is for a same group communication service data packet, and calculates a total block error rate, where a formula for calculating the total block error rate is:

$$\frac{Quantity of NACKs}{Quantity of NACKs + Quantity of ACKs} ,$$

that is, a value obtained by dividing a quantity of received NACKs by a sum of a quantity of received ACKs and the quantity of received NACKs, and if the foregoing total block error rate exceeds a preset total block error rate threshold, performs HARQ retransmission on the foregoing group communication service data packet, that is, the group communication apparatus collects statistics about a block error proportion of each group communication service data packet for all group communication users in a cell, and controls the block error proportion of each group communication service data packet not to exceed a specific threshold; or the group communication apparatus separately collects statistics about a data transmission BLER of each UE in the foregoing M UEs, and when the foregoing M UEs receive a group communication data packet, and a BLER of at least one UE in the foregoing M UEs is greater than or equal to a preset BLER threshold, performs HARQ retransmission on the foregoing group communication data packet. That is, the group communication apparatus separately collects statistics about the data transmission BLER of each UE in the foregoing M UEs, and if BLERs of all UEs are less than the preset BLER threshold, HARQ retransmission does not need to be performed on a data packet transmitted this time; if a BLER of one or more UEs is greater than or equal to the preset BLER threshold, HARQ retransmission is performed on the data packet transmitted this time.

Calculating a BLER of one UE is used as an example, which may include but is not limited to calculation methods described below.

Method 1:

Statistics about a BLER are collected with a statistical period of regularly sending K new group communication service data packets, where K is greater than or equal to 1, and when an NACK is received (or downlink data is transmitted, but in uplink feedback, DTX is detected in a location used for receiving an ACK/NACK), the BLER of the user is 1/K, and so on. It is assumed that, K=10, and a preset BLER threshold is 60%, after the group communication apparatus sends a group communication data packet to UE, feedback of an NACK is received, or DTX is detected in a feedback time, and the group communication apparatus acquires feedback information with respect to information about nine group communication service data packets sent before the UE sends the group communication service data packet; if in the feedback information of the nine group communication service data packets, there are four ACKs and three NACKs, and DTX is detected in two locations for receiving an ACK/NACK, the BLER of the UE is 60%, which is obtained by dividing a sum of a quantity of NACKs and a quantity of locations in which DTX is detected in a statistical period by K.

Method 2:

Statistics about a BLER are collected in a filtering manner. If an ACK is received, an instantaneous value of a current BLER is 0; if an NACK is received (or downlink data is transmitted, but in uplink feedback, DTX is detected in a location used for receiving an ACK/NACK), an instantaneous value of a current BLER is 100%.

BLER filtering value [i]=BLER filtering value [i−1]×(1−alpha)+alpha×BLER instantaneous value, where i is greater than or equal to 1, and i represents a serial number of a current data packet.

alpha is a filtering coefficient.

That is, if a BLER filtering value is greater than or equal to the preset BLER threshold, HARQ retransmission is performed.

In the foregoing embodiment, if the foregoing N UEs have a capability of supporting multiple carriers, the group communication apparatus may map, at a first frequency channel number, original data of the group communication service data packet to the physical downlink shared channel for transmission, and map, at a second frequency channel number, the corresponding to-be-retransmitted group communication service data packet to the physical downlink shared channel for performing HARQ retransmission.

In the foregoing embodiment, the group communication apparatus determines to map the foregoing group communication service data packet to the physical multicast channel for transmission; and the group communication apparatus maps the foregoing group communication service data packet to the physical downlink shared channel for performing HARQ retransmission. That is, if the initially transmitted data of the foregoing group communication data packet is carried on the physical multicast channel, the retransmitted data is transmitted on the physical downlink shared channel. That is, initial transmission and retransmission are performed on different physical channels.

In this embodiment, uplink feedback information is configured for some or all UEs in a group of UEs that receive group communication service data packet, so that the group communication apparatus can control downlink data transmission according to the uplink feedback information fed back by the UEs, for example, a suitable MCS is determined and HARQ retransmission is performed, which improves reliability and transmission efficiency of group communication service data packet transmission.

In the foregoing embodiment, before the controlling transmission of the group communication service data packet according to uplink feedback information fed back by M UEs in N UEs, the method further includes: receiving, by the foregoing group communication apparatus, a resource allocation request sent by the M UEs in the N UEs; and sending, by the foregoing group communication apparatus, a resource allocation response to the foregoing M UEs, where the foregoing resource allocation response includes an indication of a resource allocated for M UEs by the foregoing group communication apparatus, so that the foregoing M UEs feed back the uplink feedback information on a resource corresponding to the indication of the foregoing allocated resource.

FIG. 12 is a schematic flowchart of Embodiment 2 of a group communication method according to the present invention. A group communication apparatus executes this embodiment, and the group communication apparatus may be integrated in UE. The method in this embodiment includes the following steps.

S1201. The UE receives group communication data by using a physical downlink shared channel or a physical multicast channel.

S1202. The UE determines, according to a reported threshold carried in a received radio resource control message, whether uplink information feedback needs to be performed, where the foregoing reported threshold is a CQI threshold and/or a BLER threshold.

That is, when the group communication data is carried on the physical downlink shared channel or the physical multicast channel, a terminal determines, according to the reported threshold carried in the received radio resource control message, whether the uplink information feedback needs to be performed. The foregoing reported threshold is the CQI threshold and/or the BLER threshold. It should be noted that, in each embodiment described above, group communication has four types of data plane architectures on a network side of an access network.

In the foregoing embodiment, the determining, by the foregoing UE according to a reported threshold carried in a received radio resource control message, whether uplink information feedback needs to be performed includes: when a BLER of the foregoing group communication data received by the foregoing UE is greater than the BLER threshold, determining to perform the uplink information feedback; or when a CQI measured by the foregoing UE is less than the CQI threshold, determining to perform the uplink information feedback.

In the foregoing embodiment, specifically, after it is determined to perform the uplink information feedback, in one manner, a report is directly performed; in another manner, the foregoing UE first sends a resource allocation request to the group communication apparatus, after the foregoing UE receives a resource allocation response sent by the foregoing group communication apparatus, the foregoing UE feeds back, according to an indication, included in the foregoing resource allocation response, of a resource allocated for M UEs by the foregoing group communication apparatus, uplink feedback information on a resource corresponding to the indication of the foregoing allocated resource.

A first-type data plane architecture is shown in FIG. 6: FIG. 6 is a first-type architecture diagram of UMTS group communication on a radio access network side, where both a group communication control (GCC) functional entity and a radio link control unacknowledged mode (RLC UM) entity are oriented to a cell, and services of a same temporary mobile group identity (TMGI) in the cell are corresponding to one GCC entity and one RLC UM entity. FIG. 6 is described by using two cells as an example.

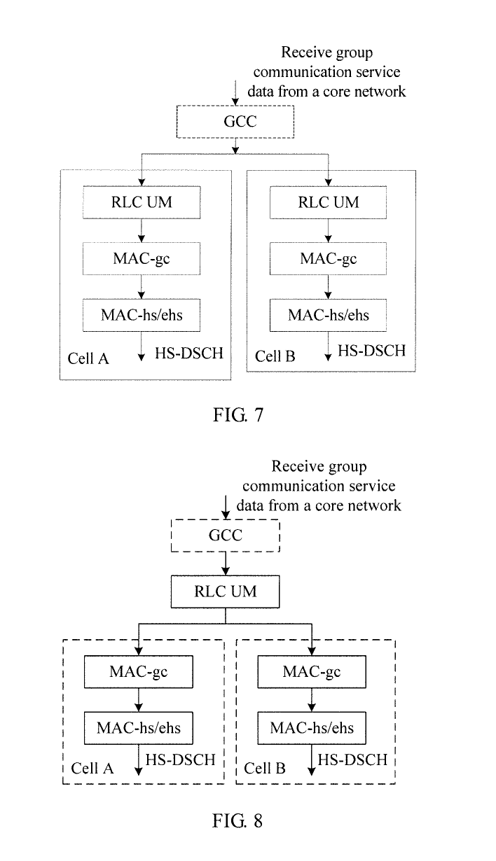

A second-type data plane architecture is shown in FIG. 7: FIG. 7 is a second-type architecture diagram of UMTS group communication on a radio access network side. A GCC entity is oriented to a second group communication apparatus, and services of a same TMGI in the second group communication apparatus are corresponding to one GCC entity; an RLC UM entity is oriented to a cell, and services of a same TMGI in the cell are corresponding to one RLC UM entity. FIG. 7 is described by using two cells as an example.

A third-type data plane architecture is shown in FIG. 8: FIG. 8 is a third-type architecture diagram of UMTS group communication on a radio access network side. Both a GCC entity and an RLC UM entity are oriented to a second group communication apparatus, and services of a same TMGI in the second group communication apparatus are corresponding to one GCC entity and one RLC UM entity. FIG. 8 is described by using two cells as an example.

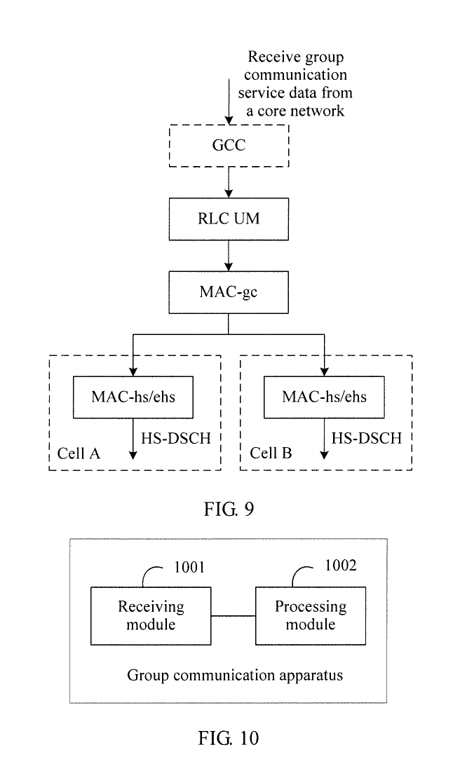

A fourth-type data plane architecture is shown in FIG. 9: FIG. 9 is a fourth-type architecture diagram of UMTS group communication on a radio access network side. All of a GCC entity, an RLC UM entity, and a MAC-gc entity are oriented to a second group communication apparatus, and services of a same TMGI in the second group communication apparatus are corresponding to one GCC entity, one RLC UM entity, and one MAC-gc entity. FIG. 9 is described by using two cells as an example.

Optionally, the GCC entity in the foregoing four types of architectures may be omitted, and some functions of the GCC are directly integrated into the RLC entity or the MAC-gc entity. Before the RLC entity, a packet data convergence protocol (PDCP) entity may also be added, which depends on configurations on the network side. The present invention constitutes no limitation thereon.

It may be clearly understood by a person skilled in the art that, for the purpose of convenient and brief description, division of the foregoing function modules is used as an example for illustration. In actual application, the foregoing functions may be allocated to different function modules and implemented according to a requirement, that is, an inner structure of an apparatus is divided into different function modules to implement all or some of the functions described above. For a detailed working process of the foregoing system, apparatus, and unit, reference may be made to a corresponding process in the foregoing method embodiments, and details are not described herein.

In the several embodiments provided in this application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the shown or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separated, and parts shown as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the foregoing integrated unit is implemented in the form of the software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in a form of a software product. The software product is stored in a storage medium and includes several instructions for instructing a computer device (which may be a personal computer, a server, or a network device) or a processor (processor) to perform all or some of the steps of the methods in the embodiments of the present application. The foregoing storage medium includes: any medium that can store program code, such as a USB flash drive, a removable hard disk, a read-only memory (ROM), a random access memory (RAM), a magnetic disk, or an optical disc.

The foregoing embodiments are merely used to describe the technical solutions of the present application. Descriptions of the foregoing embodiments are merely intended to help understand the method and core idea of the present invention, and shall not be construed as a limitation on the present invention. Any variation or replacement readily figured out by a person skilled in the art within the technical scope disclosed in the present invention shall fall within the protection scope of the present invention.

What is claimed is:

1. A group communication method, comprising:
determining, by a group communication apparatus, whether a received downlink data packet is a group communication service data packet, wherein the group communication service data packet is corresponding to a group of user equipments (UEs), the group of UEs comprise N UEs, and N is an integer that is greater than or equal to 1; and
if the downlink data packet received by the group communication apparatus is the group communication service data packet, determining, by the group communication apparatus, to transmit the group communication service data packet on a physical downlink shared channel or a physical multicast channel, and controlling transmission of the group communication service data packet according to uplink feedback information fed back by M UEs in the N UEs, wherein M is an integer that is greater than or equal to 1, and 1≦M≦N.

2. The method according to claim 1, wherein the controlling transmission of the group communication service data packet according to uplink feedback information fed back by M UEs in the N UEs comprises:
determining, by the group communication apparatus according to the uplink feedback information fed back by the M UEs in the N UEs, a modulation and coding scheme (MCS) used to transmit the group communication service data packet; and/or
performing, by the group communication apparatus, a hybrid automatic repeat request (HARQ) retransmission decision according to the uplink feedback information fed back by the M UEs in the N UEs, and if a result of the decision is retransmission, performing, by the group communication apparatus, HARQ retransmission on the group communication service data packet.

3. The method according to claim 1, wherein when the group communication apparatus is an evolved NodeB, the method further comprises:
configuring, by the group communication apparatus, the uplink feedback information of the M UEs in the N UEs, wherein 1≦M≦N, and the M UEs are UEs, in the N UEs, that are determined by the group communication apparatus and that satisfy a preset condition; wherein
the preset condition is at least one of the following conditions:
all UEs in the N UEs;
UE, in the N UEs, whose reference signal received power (RSRP) is less than a preset RSRP threshold or reference signal received quality (RSRQ) is less than a preset RSRQ threshold;
UE, in the N UEs, whose CQI is less than a preset CQI threshold;
UE, in the N UEs, whose data transmission BLER on the physical downlink shared channel or the physical multicast channel is greater than a preset BLER threshold; and
UE, in the N UEs, that is in a handover area.

4. The method according to claim 1, wherein when the group communication apparatus is a base station, the controlling transmission of the group communication service data packet comprises:
controlling, by the group communication apparatus, the transmission of the group communication service data packet according to the uplink feedback information fed back by the M UEs, in the N UEs, that are configured by a radio network controller (RNC) corresponding to the group communication apparatus, wherein the M UEs, in the N UEs, configured by the RNC are UEs that satisfy a preset condition; wherein
the preset condition is at least one of the following conditions:
all UEs in the N UEs;
UE, in the N UEs, whose received signal code power RSCP is less than a preset RSCP threshold or
$$\frac{{E}_{c}}{{I}_{o}}$$
is less than a preset
$$\frac{{E}_{c}}{{I}_{o}}$$
threshold;
UE, in the N UEs, whose CQI is less than a preset CQI threshold;
UE, in the N UEs, whose data transmission BLER on the physical downlink shared channel or the physical multicast channel is greater than a preset BLER threshold; and
UE, in the N UEs, that is in a handover area or a softer handover area.

5. The method according to claim 1, wherein the method further comprises:
sending, by the group communication apparatus, a reported threshold to the N UEs by using a radio resource control message, wherein the reported threshold is a CQI threshold and/or a BLER threshold, so that each UE in the N UEs determines, according to the reported threshold, whether to perform uplink information feedback.

6. The method according to claim 1, wherein before the controlling the transmission of the group communication service data packet, the method further comprises:
receiving, by the group communication apparatus, a resource allocation request sent by the M UEs in the N UEs; and
sending, by the group communication apparatus, a resource allocation response to the M UEs, wherein the resource allocation response comprises an indication of a resource allocated for the M UEs by the group communication apparatus, so that the M UEs feed back the uplink feedback information on a resource corresponding to the indication of the allocated resource.

7. A group communication method, comprising:
receiving, by user equipment UE, group communication data by using a physical downlink shared channel or a physical multicast channel; and
determining, by the UE according to a reported threshold carried in a received radio resource control message, whether uplink information feedback needs to be performed, wherein the reported threshold is a channel quality indicator (CQI) threshold and/or a block error rate (BLER) threshold.

8. The method according to claim 7, wherein the determining whether the uplink information feedback needs to be performed comprises:
when a BLER of the group communication data received by UE is greater than the BLER threshold, determining to perform the uplink information feedback; or
when a CQI measured by the UE is less than the CQI threshold, determining to perform the uplink information feedback.

9. The method according to claim 8, wherein after the determining to perform the uplink information feedback, the method further comprises:
sending, by the UE, a resource allocation request to a group communication apparatus;
receiving, by the UE, a resource allocation response sent by the group communication apparatus, wherein the resource allocation response comprises an indication of a resource allocated for M UEs by the group communication apparatus; and
feeding back, by the UE, uplink feedback information on a resource corresponding to the indication of the allocated resource.

10. A group communication apparatus, comprising:
a receiver, configured to receive a downlink data packet; and
a processor, configured to: determine whether the received downlink data packet is a group communication service data packet, wherein the group communication service data packet is corresponding to a group of user equipments (UEs), the group of UEs comprise N UEs, and N is an integer that is greater than or equal to 1; and if the received downlink data packet is the group communication service data packet, determine to transmit the group communication service data packet on a physical downlink shared channel or a physical multicast channel, and control transmission of the group communication service data packet according to uplink feedback information fed back by M UEs in the N UEs, wherein M is an integer that is greater than or equal to 1, and 1≦M≦N.

11. The apparatus according to claim 10, wherein the processor is specifically configured to: determine, according to the uplink feedback information fed back by the M UEs in the N UEs, a modulation and coding scheme (MCS) used to transmit the group communication service data packet; and/or perform a hybrid automatic repeat request (HARQ) retransmission decision according to the uplink feedback information fed back by the M UEs in the N UEs, and if a result of the decision is retransmission, perform HARQ retransmission on the group communication service data packet.

12. The apparatus according to claim 11, wherein the uplink feedback information comprises: a channel quality indicator (CQI); and
the processor is further configured to: rank received current CQI values fed back by the M UEs, and determine, according to a current CQI value that is ranked in the L^{th} place, the MCS used to transmit the group communication service data packet, wherein L is an integer that is greater than or equal to 1, and 1≦L≦M; or determine, according to a current CQI value of UE whose average CQI value is the smallest in the M UEs, the MCS used to transmit the group communication service data packet; or rank received current CQI values fed back by the M UEs, and determine, according to an average value of current CQI values that are ranked from the R^{th} place to the Q^{th} place, the MCS used to transmit the group communication service data packet, wherein R is an integer that is greater than or equal to 1, Q is an integer that is greater than or equal to 2, and 1≦R≦Q≦M.

13. The apparatus according to claim 11, wherein the uplink feedback information further comprises: an acknowledgment (ACK) or a negative acknowledgment (NACK); and
the processor is further configured to: if an NACK fed back by at least one UE in the M UEs is received, perform, on the physical downlink shared channel, HARQ retransmission on a group communication service data packet corresponding to the NACK; or collect statistics about received ACK and NACK information that is fed back by the M UEs by using an uplink feedback channel and that is for a same group communication service data packet, calculate a total block error rate, and if the total block error rate is greater than or equal to a preset total block error rate threshold, perform HARQ retransmission on the group communication service data packet on the physical downlink shared channel; or separately collect statistics about a data transmission block error rate (BLER) of each UE in the M UEs, and when the M UEs receive a group communication data packet, and a BLER of at least one UE in the M UEs is greater than or equal to a preset BLER threshold, perform HARQ retransmission on the group communication data packet on the physical downlink shared channel.

14. The apparatus according to claim 11, wherein if the N UEs have a capability of supporting multiple carriers, the processor is further configured to: determine to map, at a first frequency channel number, the corresponding group communication service data packet to the physical downlink shared channel for transmission; and map, at a second frequency channel number, the corresponding group communication service data packet to the physical downlink shared channel for performing HARQ retransmission.

15. The apparatus according to claim 11, wherein the processor is further configured to: determine to map the group communication service data packet to the physical multicast channel for transmission; and map the group communication service data packet to the physical downlink shared channel for performing HARQ retransmission.

16. The apparatus according to claim 10, wherein when the group communication apparatus is an evolved NodeB, the processor is further configured to configure the uplink feedback information of the M UEs in the N UEs, wherein 1≦M≦N, and the M UEs are UEs, in the N UEs, that are determined by the group communication apparatus and that satisfy a preset condition; wherein
the preset condition is at least one of the following conditions:
all UEs in the N UEs;
UE, in the N UEs, whose reference signal received power (RSRP) is less than a preset RSRP threshold or reference signal received quality (RSRQ) is less than a preset RSRQ threshold;
UE, in the N UEs, whose CQI is less than a preset CQI threshold;
UE, in the N UEs, whose data transmission BLER on the physical downlink shared channel or the physical multicast channel is greater than a preset BLER threshold; and
UE, in the N UEs, that is in a handover area.

17. The apparatus according to claim 10, wherein when the group communication apparatus is a base station, the processor is further configured to control the transmission of the group communication service data packet according to the uplink feedback information fed back by the M UEs, in the N UEs, that are configured by a radio network controller (RNC) corresponding to the group communication apparatus, wherein the M UEs, in the N UEs, configured by the RNC are UEs that satisfy a preset condition; wherein
the preset condition is at least one of the following conditions:
all UEs in the N UEs;
UE, in the N UEs, whose received signal code power RSCP is less than a preset RSCP threshold or
$$\frac{{E}_{c}}{{I}_{o}}$$
is less than a preset
$$\frac{{E}_{c}}{{I}_{o}}$$
threshold;
UE, in the N UEs, whose CQI is less than a preset CQI threshold;
UE, in the N UEs, whose data transmission BLER on the physical downlink shared channel or the physical multicast channel is greater than a preset BLER threshold; and
UE, in the N UEs, that is in a handover area or a softer handover area.

18. The apparatus according to claim 10, wherein the processor is further configured to send a reported threshold to the N UEs by using a radio resource control message, wherein the reported threshold is a CQI threshold and/or a BLER threshold, so that each UE in the N UEs determines, according to the reported threshold, whether to perform uplink information feedback.

19. The apparatus according to claim 10, wherein
the receiver is further configured to receive a resource allocation request sent by the M UEs in the N UEs; and
the apparatus further comprises a transmitter, configured to send a resource allocation response to the M UEs, wherein the resource allocation response comprises an indication of a resource allocated for the M UEs, so that the M UEs feed back the uplink feedback information on a resource corresponding to the indication of the allocated resource.

20. A group communication apparatus, comprising:
a receiver, configured to receive group communication data by using a physical downlink shared channel or a physical multicast channel; and
a processor, configured to determine, according to a reported threshold carried in a received radio resource control message, whether uplink information feedback needs to be performed, wherein the reported threshold is a channel quality indicator (CQI) threshold and/or a block error rate (BLER) threshold.

21. The apparatus according to claim 20, wherein the processor is further configured to:
when a BLER of the group communication data received by UE is greater than the BLER threshold, determine to perform the uplink information feedback; or when a CQI measured by the UE is less than the CQI threshold, determine to perform the uplink information feedback.

22. The apparatus according to claim 21, further comprising:
a transmitter, configured to send a resource allocation request to the group communication apparatus; wherein
the receiver is further configured to receive a resource allocation response sent by the group communication apparatus, wherein the resource allocation response comprises an indication of a resource allocated for M UEs by the group communication apparatus; and
the processor is further configured to feed back uplink feedback information on a resource corresponding to the indication of the allocated resource.
